(19) United States
(12) Patent Application Publication
(10) Pub. No.: US 2013/0263182 A1
(43) Pub. Date: Oct. 3, 2013

(54) CUSTOMIZING ADDITIONAL CONTENT PROVIDED WITH VIDEO ADVERTISEMENTS

(71) Applicants: Jessica P. Ivy, Venice, CA (US); Arash Nikkar, La Crescenta, CA (US); Huy D. Truong, New York, NY (US); Robert H. Lanham, Commerce Township, MI (US)

(72) Inventors: Jessica P. Ivy, Venice, CA (US); Arash Nikkar, La Crescenta, CA (US); Huy D. Truong, New York, NY (US); Robert H. Lanham, Commerce Township, MI (US)

(73) Assignee: HULU LLC, Los Angeles, CA (US)

(21) Appl. No.: 13/435,892

(22) Filed: Mar. 30, 2012

(51) Int. Cl. H04N 21/458

(52) U.S. Cl. 725/34

(57) ABSTRACT

A computer customizes additional content provided with video advertisements in a video segment, by identifying a video advertisement included in a segment of video content streaming to a client device, determining a parameter of the client device or of a user of the client device, and selecting customized advertising content from multiple predetermined advertising choices, based on the parameter and on an identity of the video advertisement. An interactive ad object may be provided at a time determined by timing of the video ad in a streaming video session. The interactive ad object may include a link to additional information related to the video ad. The link may be customized for a particular client device and video session, for example by linking to the customized advertising content at a remote server.

### FIELD

The present application relates generally to input/output processing using a computer, and more particularly to customizing additional electronic content (e.g., digital data) provided with a video advertisement being played by a media player, based on a parameter of a client device playing the video advertisement, or of an identified user of the client device.

### BACKGROUND

Advertising-supported distribution of audio-video data may be implemented from a content server to remote client devices over computer networks, telecommunications networks, and combinations of such networks, using various methods, for example progressive downloading or streaming.

In streaming, a server streams audio-video data continuously to a media player component operating at least partly on the client device, which may play the audio-video data concurrently with receiving the streaming data from the server. The media player component may initiate play of the video data immediately after receiving an initial portion of the data from the content provider. Traditional streaming techniques use a single provider delivering a stream of data to a set of end users. High bandwidths and processing power may be required to deliver a single stream to a large audience, and the required bandwidth of the provider may increase as the number of end users increases.

Unlike progressive downloading, streaming media can be delivered on-demand or live. Wherein progressive download requires downloading the entire file or downloading enough of the entire file to start playback at the beginning, streaming enables immediate playback at any point within the file. End-users may skip through the media file to start playback or change playback to any point in the media file. Hence, the end-user does not need to wait for the file to progressively download. Typically, streaming media is delivered from a few dedicated servers having high bandwidth capabilities.

A streaming media server is a specialized device that accepts requests for video files, and with information about the format, bandwidth and structure of those files, delivers just the amount of data necessary to play the video, at the rate needed to play it. Streaming media servers may also account for the transmission bandwidth and capabilities of the media player on the destination client. Unlike the web server, the streaming media server communicates with the client device using control messages and data messages to adjust to changing network conditions as the video is played. These control messages can include commands for enabling control functions such as fast forward, fast reverse, pausing, or seeking to a particular part of the file at the client. Since a streaming media server transmits video data only as needed and at the rate that is needed, precise control over the number of streams served can be maintained. Unlike the case with progressive downloading, the viewer will not be able to view high data rate videos over a lower data rate transmission medium. However, streaming media servers (1) provide users random access to the video file, (2) allows monitoring of who is viewing what video programs and how long they are watched (3) use transmission bandwidth more efficiently, since only the amount of data required to support the viewing experience is transmitted, and (4) the video file is not stored in the viewer's computer, but discarded by the media player, thus allowing more control over the content.

Streaming media servers may use HTTP and TCP to deliver video streams, but generally use RSTP (real time streaming protocol) and UDP (user datagram protocol). These protocols permit control messages and save bandwidth by reducing overhead. Unlike TCP, when data is dropped during transmission, UDP does not transmit resent requests. Instead, the server continues to send data. Streaming media servers can also deliver live webcasts and can multicast, which allows more than one client to tune into a single stream, thus saving bandwidth.

Typically, progressively downloaded media is transmitted to the user device at a rate that is faster than playback. The media program player buffers this data, and may indicate how much of the media program has been buffered by providing an indicator, usually as a part of a “progress bar.” A control is often provided that allows the user to go to any point in the program that has already been buffered by selecting the control and moving it to a different location along the progress bar. This allows the user to randomly access any buffered portion of the media program. Streaming media players do not rely on buffering to provide random access to any point in the media program. Instead, this is accomplished through the use of control messages transmitted from the media player to the streaming media server.

The delivery of video content by streaming or progressive download may be accomplished under a variety of models. In one model, the user pays for the viewing of each video program, for example, using a pay-per-view service. In another model widely adopted by broadcast television shortly after its inception, sponsors pay for the presentation of the media program in exchange for the right to present advertisements during or adjacent to the presentation of the program. In some models, advertisements are inserted at predetermined times in a video program, which times may be referred to as “ad slots” or “ad breaks.” With streaming video, the media player may be configured so that the client device cannot play the video without also playing predetermined advertisements during the designated ad slots.

Output from a media player on the client device may occupy only a portion of total screen area available on a client device, particularly when bandwidth limitations restrict the resolution of streaming video. Although media players often include a “full screen” viewing option, many users prefer to watch video in a display area smaller than full screen, depending on the available video resolution. Accordingly, the video may appear in a relatively small area or window of an available display area, leaving unused areas. A video provider may occupy the unused area with other content or interface objects, including additional advertising, such as, for example, banner ads. Banner ads or similar additional content may be provided with links to an additional web site or page, so that when a user “clicks on” or otherwise selects the banner ad, the additional web site or page opens in a new window.

While providing additional content with links synchronized to video advertisements appearing in a streaming video window may be helpful for enhancing the effectiveness of video advertising, it may be difficult to ensure that the links point to content that is most appropriate for a particular client or user. For example, when ads are served in connection with a video streaming service that services clients located over a very large and diverse region, preparing and providing different advertising materials in different areas or for different demographic targets may become undesirably expensive or time consuming. These and other limitations of prior methods for providing additional content synchronized to video advertisements appearing in a streaming video may be overcome by the novel methods and apparatus disclosed herein.

### SUMMARY

Methods, apparatus and systems for customizing additional electronic content provided with a video advertisement being played by a media player are described in detail in the detailed description, and certain aspects are summarized below. This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

A computer server in communication with one or more client devices, alone or in cooperation with the one or more client devices, or a client device, may perform a method for customizing additional content provided with advertisements in a video segment. The method may include identifying a video advertisement included in a segment of video content streaming to a client device. As used herein, a video segment refers to a definite portion of frame-based video data, such as may be used in a streaming video session to view a television episode, motion picture, recorded live performance, or other video content. Optionally, the method may include providing an interactive ad object, for example a companion banner ad, Adobe Flash™ overlay object, or other interactive ad object to the client device at a time determined by timing of the video ad. The interactive ad object may include a link to additional information related to the video ad. However, the link may be customized for a particular client device and video session, such as described below. For example, the link may point to the customized advertising content described below.

The method may further include determining a parameter of the client device or of a user of the client device. For example, the parameter may include a geographic location, or estimated geographic location of the client device, or a demographic characteristic of the user of the client device.

The method may further include selecting customized advertising content from multiple predetermined advertising choices, based on the parameter and on an identity of the video advertisement. For example, the customized content may be, or may include, information for display in a web page or the like. The method may further include providing the customized advertising content for display on a display component of the client device in connection with the video advertisement.

In an aspect, the method may include determining the parameter based on information received from the client device in connection with a request for the video content. Determining the parameter may include, for example, determining an estimated geographical location of the client device, for example, based on a network address from which the request originates, or based on location information included in or with the request. For further example, determining the parameter may include determining a demographic parameter of a person identified via a user account in use on the client device, based on user profile information associated with a user account, a history of use associated with the account, or a combination of such information.

In another aspect, selecting the customized advertising content may include looking up a network address for the customized advertising content in a relational data structure, based on the parameter and on an identity of the video advertisement. The relational data structure may include links (e.g., Uniform Resource Locators (URLs) or other network addresses) for respective different advertising content, indexed to one or more parameters and video ad identifiers. For example, the database may include links to different web sites or online advertisements belonging to respective different local automobile dealers, all associated via a relationship in the relational data structure to a video ad for an automobile to be distributed nationally in video content of a video distribution system. In addition, the relational data structure may relate each of the different web sites or online advertisements to one or more unique local area identifiers. Therefore, the server or other entity may query the relational data structure based on a local area identifier and video ad identifier to identify and select one of different web sites or online advertisements for local dealers, and provide the information appropriate for the client device's location. Accordingly, the method may include maintaining the relational data structure defining different advertising choices in relation to different parameter values for at least one video advertisement. Timing for selecting and providing the customized ad content may be based on the timing at which the video ad appears in a streaming video session.

In an aspect, the method may include providing the network address for the customized advertising content from the at least one computer to the client device. For example, the method may further include providing the video advertisement including an interactive object for generating a request for the customized advertising content. The interactive object may include, for example, a companion banner ad, Adobe Flash™ overlay object, or other interactive ad object provided for display on the client device during presentation of the video ad.

In some embodiments, the data structure used for defining relationships between the parameters, video ad identifiers and customized ad content may be maintained at a network entity, and not provided to the client device at any time. In alternative embodiments, the method may include providing the data structure to the client device. For example, in an aspect, the method may include receiving the data structure with the video advertisement, by the client device. In such embodiments, looking up the network address may be performed by the client device. In the alternative, the method may include the client device receiving a network address for the customized advertising content from a network server. Then, the method may include the client device requesting the customized advertising content, using the network address.

In an aspect, selecting the customized advertising content may be performed by the server in response to a request from the client device. For example, the method may further include generating a request for the customized advertising content at the client device, by detecting user input selecting an interactive object included in the video advertisement.

In another aspect of the method, providing the customized advertising content may include providing a web page including the customized advertising content configured for display in a window separate from the video advertising. In the alternative, or in addition, providing the customized advertising content may include displaying the customized advertising content in a separate window from the video advertising. For further example, providing the customized advertising content may include providing a banner including the customized advertising content configured for display in a window with the video advertising, or displaying a banner including the customized advertising content in a window with the video advertising.

In related aspects, a client-side or server-side computing apparatus may be provided for performing any of the methods and aspects of the methods summarized above. An apparatus may include, for example, a processor coupled to a memory, wherein the memory holds instructions for execution by the processor to cause the apparatus to perform operations as described above. Certain aspects of such apparatus (e.g., hardware aspects) may be exemplified by equipment such as computer servers, personal computers, network-enabled televisions, set-top boxes, smart phones, notepad or palm computers, laptop computers, and other computing devices of various types used for providing or accessing information over a computer network. Similarly, an article of manufacture may be provided, including a non-transitory computer-readable medium holding encoded instructions, which when executed by a processor, may cause a client-side or server-side computing apparatus to perform the methods and aspects of the methods as summarized above.

Further embodiments, aspects and details of methods, apparatus and systems for customizing additional electronic content provided with a video advertisement being played by a media player are presented in the detailed description that follows.

### BRIEF DESCRIPTION OF THE DRAWINGS

The present technology, in accordance with one or more various embodiments, is described in detail with reference to the following figures. The drawings are provided for purposes of illustration only and merely depict typical or example embodiments of the technology. These drawings are provided to facilitate the reader's understanding of the technology and shall not be considered limiting of the breadth, scope, or applicability of the technology. Like element numerals may be used to indicate like elements appearing in one or more of the figures.

FIG. 1 is a schematic diagram illustrating an embodiment of a computing environment in which systems and methods discussed herein may be implemented.

FIG. 2 is a schematic block diagram illustrating an embodiment of a client device for supporting and executing the systems and methods described herein.

FIG. 3 is a state diagram illustrating general aspects of an advertisement customization process as used for configuring additional advertising in connection with video ads in a streaming video segment.

FIG. 4 is a line diagram illustrating aspects of a video segment including ad slots.

FIGS. 5-7 are sequence diagrams illustrating examples of call flows between system components in a sequence for customizing additional content provided with advertisements in a video segment.

FIG. 8 is a diagram illustrating a simplified data structure for recording relationships or associations between video ad identifiers, location or demographic parameters, and addresses for additional content.

FIG. 9 is a diagram illustrating a simplified screenshot of a user interface and related features for customizing additional content provided with advertisements in a video segment.

FIG. 10 is a diagram illustrating an example of customized additional content in a window of a graphical user interface.

FIG. 11 is a diagram illustrating a simplified screenshot of a user interface and related features in an alternative embodiment for displaying user-selected advertisements in a video segment.

FIGS. 12-17 are diagrams illustrating operations that may be performed by a client or server node for customizing additional content provided with advertisements in a video segment.

FIG. 18 is a diagram illustrating a client or server node configured for customizing additional content provided with advertisements in a video segment.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiments may be practiced without these specific details. In other instances, well-known structures and devices are shown in block diagram form in order to facilitate describing one or more embodiments.

Features and aspects as disclosed herein may be implemented within a system including a video streaming system 100 in communication with multiple client devices via one or more communication networks. The video streaming system 100 may include one or more computer servers or modules 102, 104, 106, 108 and/or 110 distributed over one or more computers. Each server 102, 104, 110 may include, or may be operatively coupled to, one or more data stores, for example databases, indexes, files, or other data structures. A video content server 102 may access a data store of various video segments; for example, television episodes, motion pictures, and other content produced as primary content of interest to consumers. The video content server 102 may serve the video segments as directed by a user interface controller module 108.

A video advertising server 104 may access a data store of relatively short videos (e.g., 10 second, 30 second, or 60 second video advertisements) configured as advertising for a particular advertiser or message. The advertising may be provided for an advertiser in exchange for payment of same kind, or may comprise a promotional message for the system 100, a public service message, or some other information. The ad server 104 may serve the video advertising segments as directed by the user interface controller 108.

An additional content server 110 may access a data store of additional advertising content related to one or more of the video advertising segments. The additional advertising content may comprise, for example, web pages, banner ads, additional video ads, audio ads, or other electronic content stored in digital form in a computer-readable medium accessible to the content server. The content server may include, or may be coupled to, a database or other relational data structure (not shown) defining relationships between the additional content and one or more of the video ads to be included in a streaming video segment. Such relationships may be used to identify and indicate additional content that is to be delivered to a client device and output for presentation to a user, for a limited time period based on a time at which the related streaming video ad is playing at the client device. There may be a topical relationship between the additional content and the related video ad, such as, for example, between a nationally distributed product that is the subject of the streaming video ad, and various local distributors or vendors for the product in different areas.

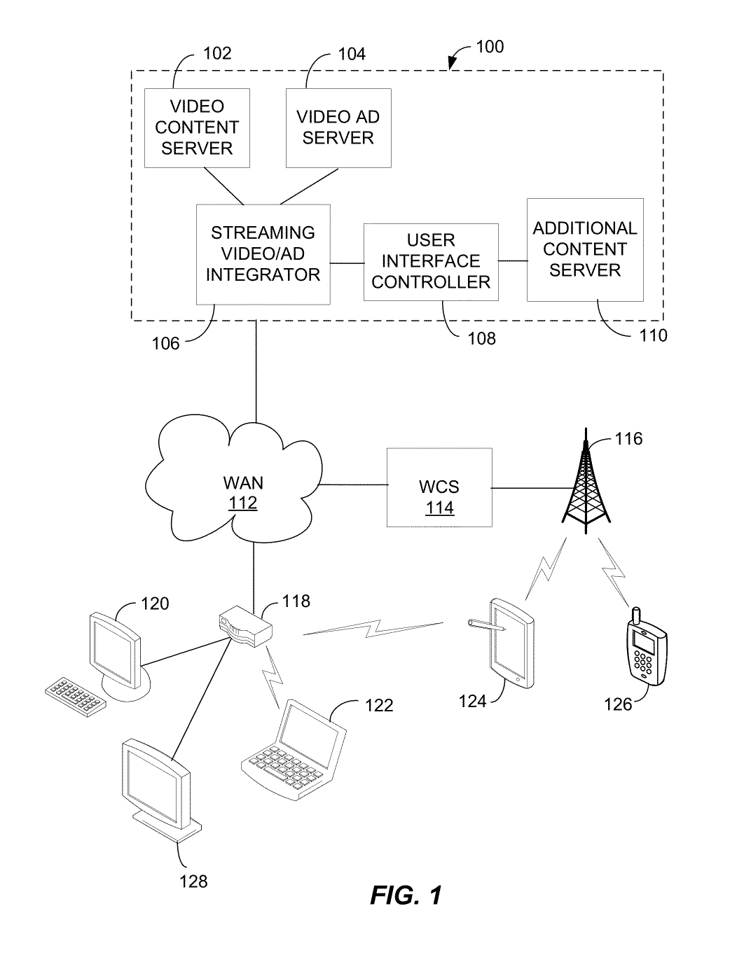

The video streaming system 100 may further include an integrator component 106 that integrates video content and video advertising into a streaming video segment as directed by the controller 108. The controller 108 may determine the selection or configuration of advertising in the streaming video based on any suitable algorithm or process. The video streaming system 100 may include other modules or units not depicted in FIG. 1, for example administrative servers, commerce servers, network infrastructure, advertising selection engines, and so forth.

The video streaming system 100 may connect to a data communication network 112. A data communication network 112 may comprise a local area network (LAN), a wide area network (WAN), for example, the Internet, a telephone network, a wireless cellular telecommunications network 114, or some combination of these or similar networks.

One or more client devices may be in communication with the video streaming system 100, via the data communication network 116 and/or other network 114. Such client devices may include, for example, one or more laptop computers 122, desktop computers 120, “smart” mobile phones 126, notepad devices 124, network-enabled televisions 128, or combinations thereof. Each of the client devices may be communicatively coupled to the video streaming system 100 via a router 118 for a LAN, via a base station 116 for a wireless telephony network 114, or via some other connection. In operation, such client devices 120, 122, 124, 126, 128 may send and receive data or instructions to the system 100, in response to user input received from user input devices or other input. In response, the system 100 may serve video segments and customized additional advertising content to the client devices 120, 122, 124, 126, 128 and customize the additional content based on parameters of the client devices, for example respective geographic locations of the client devices, or demographic information concerning respective users of the client devices. The devices 120, 122, 124, 126, 128 may output video and game content from the streaming video segment and game application using a display screen, projector, or other video output device. In certain embodiments, the system 100 configured in accordance with the features and aspects disclosed herein may be configured to operate within or support a cloud computing environment. For example, a portion of, or all of, the servers 102, 104 or 110 may reside in a cloud server.

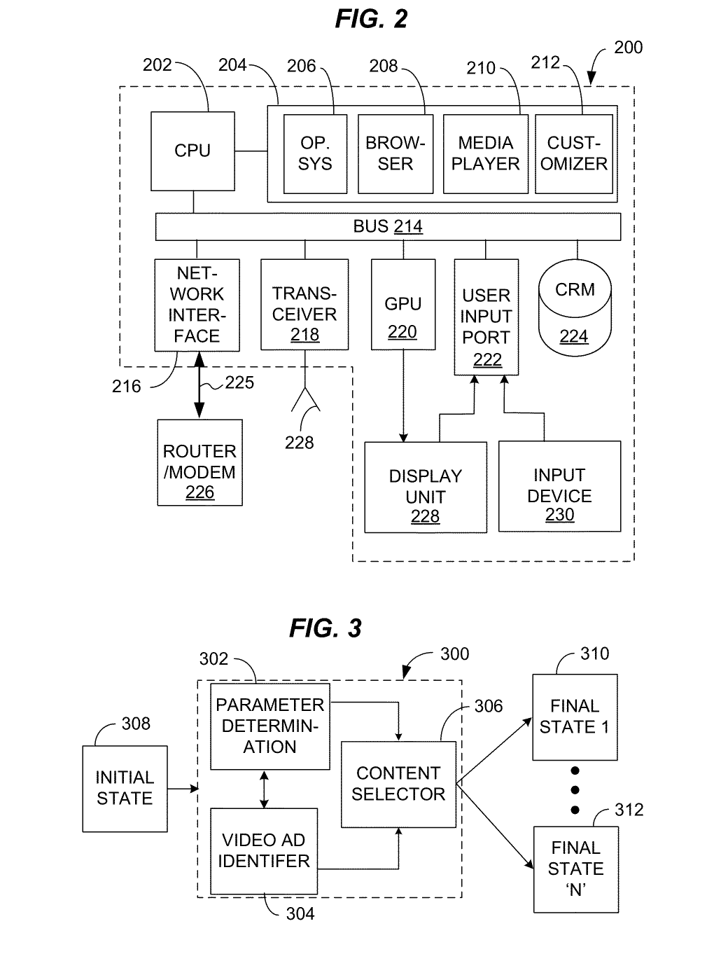

Referring to FIG. 2, a diagrammatic view of an example client device 200 is illustrated. One or more of the client devices 120, 122, 124, 126, 128 shown in FIG. 1 may be configured as or include such a client device 200, which may also be referred to as a computer, client, or client computer. In selected embodiments, the client device 200 may include a processor 202 operatively coupled to a processor memory 204, which holds binary-coded functional modules for execution by the processor 202. Such functional modules may include an operating system 206 for handling system functions such as input/output and memory access, a browser 208 for accessing information via the World Wide Web or similar network infrastructure, a media player 210 for playing streaming video and communicating with a streaming video system, and a customizer application 212 for customizing additional advertising content in connection with specific streaming video ads being played by the media player 210.

A bus 214 or other communication component may support communication of information within the computer 200. The processor 202 may be a specialized or dedicated microprocessor configured to perform particular tasks in accordance with the features and aspects disclosed herein by executing machine-readable software code defining the particular tasks. Processor memory 204 (e.g., random access memory (RAM) or other dynamic storage device) may be connected to the bus 214 or directly to the processor 202, and store information and instructions to be executed by a processor 202. The memory 204 may also store temporary variables or other intermediate information during execution of such instructions.

A computer-readable medium in a storage device 224 may be connected to the bus 214 and store static information and instructions for the processor 202; for example, the storage device 224 may store the modules 206, 208, 210 and 212 when the client device 200 is powered off, from which the modules may be loaded into the processor memory 204 when the client 200 is powered up. The storage device 224 may include a non-transitory computer-readable medium holding information, instructions, or some combination thereof, for example instructions that when executed by the processor 202, cause the client device 200 to perform one or more operations of a method as described herein.

A communication interface 216 may also be connected to the bus 214. The communication interface 216 may provide or support two-way data communication between the client device 200 and one or more external devices, e.g., the streaming system 100, optionally via a router/modem 226 and a wired or wireless connection 225. In the alternative, or in addition, the client device 200 may include a transceiver 218 connected to an antenna 228, through which the client 200 may communicate wirelessly with a base station for a wireless communication system or with the router/modem 226.

The client device 200 may be connected (e.g., via the bus 214 and graphics processing unit 220) to a display component 228. A display component 228 may include any suitable configuration for displaying information to a user of the client device 200. For example, a display component 228 may include or utilize a cathode ray tube (CRT), liquid crystal display (LCD), touchscreen LCD (e.g., capacitive display), light emitting diode (LED) display, projector, or other display device to present information to a user of the client device 200 in a visual display.

One or more input devices 230 (e.g., an alphanumeric keyboard, microphone, keypad, remote controller, game controller, camera or camera array) may be connected to the bus 214 via a user input port 222 to communicate information and commands to the client 200. In selected embodiments, an input device 230 may provide or support control over the positioning of a cursor. Such a cursor control device, also called a pointing device, may be configured as a mouse, a trackball, a track pad, touch screen, cursor direction keys or other device for receiving or tracking physical movement and translating the movement into electrical signals indicating cursor movement. The cursor control device may be incorporated into the display unit 228, for example using a touch sensitive screen. A cursor control device may communicate direction information and command selections to the processor 202 and control cursor movement on the display 228. A cursor control device may have two or more degrees of freedom, for example allowing the device to specify cursor positions in a plane or three-dimensional space.

The client device 200 may be used to transmit, receive, display, or otherwise process one or more streaming video segments. In selected embodiments, such transmitting, receiving, and displaying may be in response to the processor 202 executing one or more sequences of one or more instructions contained in main memory 204. Such instructions may be read into main memory 204 from another non-transitory computer-readable medium (e.g., a storage device 224).

Execution of sequences of instructions contained in main memory 204 may cause a processor 202 to perform one or more of the procedures or steps described herein. In selected embodiments, one or more processors 202 in a multi-processing arrangement may also be employed to execute sequences of instructions contained in main memory 204. Alternatively, or in addition thereto, firmware may be used in place of, or in combination with, software instructions to implement procedures or steps in accordance with the features and aspects disclosed herein. Thus, embodiments in accordance with the features and aspects disclosed herein may not be limited to any specific combination of hardware circuitry and software.

The term “non-transitory computer-readable medium” as used herein may refer to any medium that participates in holding instructions for execution by a processor 202, or that stores data for processing by a computer. Such a medium may take many forms, including but not limited to, non-volatile media, volatile media, and temporary storage media (e.g., cache memory). Non-volatile media may include optical or magnetic disks, such as a storage device 224. Volatile media may include dynamic memory, such as main memory 204. Common forms of non-transitory computer-readable media may include, for example, a hard (magnetic media) disk, magnetic tape, or any other magnetic medium, a CD-ROM, DVD, Blu-ray or other optical disc or medium, RAM, PROM, EPROM, FLASH-EPROM, any other memory card, chip, or cartridge, or any other memory medium from which a computer can read.

Referring to FIG. 3, general aspects of a content customization process 300 used for configuration of advertising provided to a client device based on, or in relation to, a video ad appearing in a streaming video segment on the client device are illustrated as a state diagram. The initial state 308 represents a set of possible additional advertising content for providing to client devices based on an identified streaming video advertisement segment to be played in a slot of a video streaming segment. For example, for a nationwide video ad, the set of possible advertising content may include separate links to local vendor web sites or different local promotional ad pages developed for corresponding locations across the country. The initial state 308 may be represented in a computer memory in various ways, for example by a list of advertising identifiers or links each identifying a network address for the additional advertising content, and optionally the content itself in digital form, associated with an identifier for a streaming video advertisement. It should be apparent that the initial state 308 may be defined by data that represents prospective advertisements to be displayed at a time based on when the associated video advertisement is played on the client devices. As such, the initial state data 308 represents multiple alternative physical states of a video output device that may be achieved at a later time when the one or more of the identified additional ad content is displayed or output on a client device.

The customization process 300 is (or includes) an input-output computation process performed by a computer processor, which operates on the initial state 308 to output one of several possible final states, including a first final state 310 and a last (“Nth”) final state 312. Each of the final states 310, 312, etc., likewise represents a customized additional advertising set selected from the state data 308. The customization process 300 may therefore operate as a state machine that accepts the initial state 308 and optionally user input via an input device as inputs, and transforms the state data 308 representing many possible physical states of a video output device into a definite one of the many (“N”) final states. Subsequently, the final output state is realized in physical output from a client device that is configured based on the final output state to include a specific customized advertisement.

The customization process 300 may include several interactive modules, for example, a parameter determination module 302, a video ad identification module 304 and a content selector module 306. The module 300 may include other modules, for example, a user interface module, tracking module, commerce module, graphics module, etc., which for illustrative simplicity are not shown.

The parameter determination module 302 may determine and/or discover one or more parameters of a client device or person using the client device. Such parameters may include a physical location or estimated physical location of the client device; or demographic factors such as age, gender, education level; and interest or preference data. The module 302 may determine location parameters by network address, GPS or cellular triangulation, user self reporting via a questionnaire, or other method. The module 302 may determine demographic or interest parameters by user self reporting via a questionnaire, user profile, analyzing past browsing, video viewing, or ad selection history, or other method.

The video ad identification module 304 may identify a current or upcoming video ad playing, or to be played, in a streaming video segment playing on a client device. This module 304 may read metadata in a video ad provided by a streaming video server, at the client or server layer, to discover an ad identifier for a particular video ad playing or to be played in a streaming video segment. Selection of the video ad to be played may be performed with or without user input, using one or more video ad selection algorithms that are beyond the scope of the present disclosure. In general, video ad selection may be an important aspect of a video streaming system, and many suitable selection methods are in use or may be devised. Such methods may select ads for specific video streaming sessions, such that identify of a particular ad in a particular streaming session is not fixed or determinable prior to configuration of the session at a time just prior to its initiation.

The content selector module 306 may receive inputs from the parameter determination module 302 and the video ad identifier module 304, and use those inputs for selecting additional advertising content. The selector module 306 may use a querying function in a relational database or data structure to locate additional ad content designated for use with a particular video ad and associated parameter or parameters. In addition, the selector module 306 may, through an administrative interface, participate in configurating or maintaining the relational database or data structure. The selector module may be implemented at a client or server level.

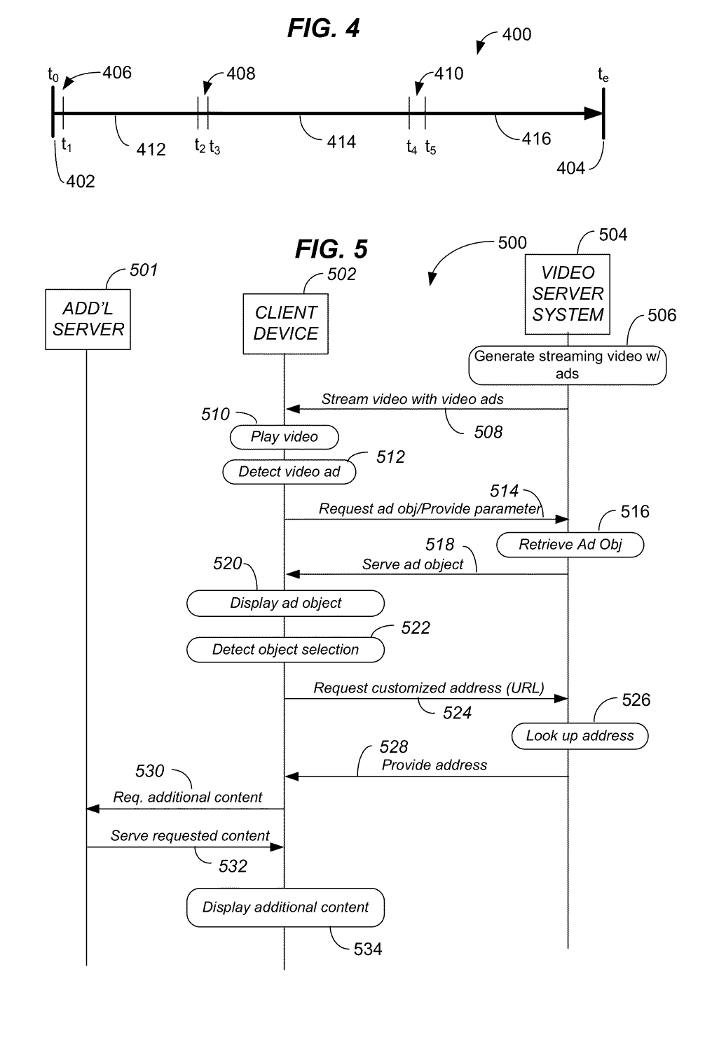

FIG. 4 is a line diagram illustrating aspects of a video segment timeline 400 including ad slots 406, 408 and 410. A video segment includes video data characterized by a sequence of video frames that are output in order at a defined frame rate to generate video output. At such, a video segment includes an initial or first frame at inception time “t₀” 402 of video output, and each subsequent frame is output at a defined time “t” after inception until a terminal or end time “tₑ” 404. Thus, each frame defines a particular time or “temporal point” in the streaming video segment, typically measured from the time of inception. For example, for a video configured for 30 frames per second, the 300^{th} frame defines a temporal point 10 seconds after inception. A temporal point in a streaming video segment may sometime be referred to herein as a “location” in relation to a progress bar, time line or other time indicator.

Any non-negative, integral number of ad slots 406, 408 and 410 may be configured in the video time line. Each ad slot may be defined by a location and duration. For example, the first ad slot 406 is located at “t₀” and has a duration of “t₁-t₀”; the second ad slot 408 is located at “t₂” and has a duration of “t₃-t₂”; and the third ad slot 410 is located at “t₄” and has a duration of “t₅-t₄”. The inter-slot portions 412, 414 and 416 are used for playing requesting video content, and the ad slots are used for playing video advertisements. A streaming media player operating on the client device may cause the video content to play in the defined inter-slot portions 412, 414, 416 and stream advertising videos of appropriate duration in all of the ad slots 406, 408, 410. The media player or an application in communication with the media player may cause additional advertising, such as companion banner ads, to be displayed for time periods based on (e.g., synchronized to) the ad slot for a related video ad.

FIG. 5 illustrates an example of a call flow 500 between a server system 504 and a client device 502 for customizing additional content provided with advertisements in a video segment. The call flow 500 may include interactions with an additional content server 501 that prepares and distributes localized or demographically targeted content related to video advertising. The servers 510, 504 and the client device 502 may each be, or may include, a computing device including one or more processors coupled to a memory and other components as described in more detail herein, or as known in the art. The call flow 500 assumes video streaming is provided through a web page interface and streaming media player installed at the client device; however, the inventive concepts herein are not limited to such environments. If a web page environment is used, a call flow may initiate with the client device 502 displaying a web (e.g., World Wide Web) page received from the server system 504 including links for requesting one or more video segments. For example, the web page may comprise a “home” or personalized page including a list of selected video segments of general interest, or selected as likely to be of interest to a specific user based on a user profile. The client device may receive user input selecting one of the links, for example, a “point and click” input from a pointing device, a touch input on a touchscreen device, or a spoken command. In response to the input, the client device may request a specific video segment by transmitting a Hypertext Transfer Protocol (HTTP) “get” request, or other suitable request message, to the server system 504.

In response to receiving the request message, the server system 504 may, at 506, determine a selection of advertising videos and ad slots for the video segment requested by the request message. In so doing, the server system may access a record pertaining to user preferences or past activity by a user identified, for example by a user account, as making the request for the video segment. Any suitable method may be used to select the video advertisements, which may include consideration of user input and related communication between the client 502 and server 504. An output of the determining process 506 may include video ad identifiers included in streaming data.

An additional content server 501 may prepare additional content, for example web pages or pop-up windows ads, to be distributed in different geographic areas or targeted to particular sets of users based on user demographic parameters. The additional content server 501 may be combined with the video server 504, in which case the additional ad server may be implemented as a component or module of the video server. In an alternative, or in addition, the additional content server 501 may be implemented as one or more machines or systems separate from the video server 504, optionally under control of independent operators. In either case, the video ad server and additional ad server may coordinate the making of associations between video advertisements, additional content, and one or more location or demographic parameters, such as by shared access to a database or other data structure. The database or other data structure may store and maintain one-to-many relationships between an address for each additional content and at least one identifier for a video ad plus at least one additional parameter (e.g., location or demographic parameter). For example, a national video ad may be associated by the relationships in the data structure to multiple additional web pages or web sites each associated with a different geographic region and URL address.

At 508, the server system 504 may stream the video segment configured with video advertising. At 510, the client device may play the streaming video segment configured with video advertising at designated ad slots using a media player component. Video advertisements may be selected by the server system 504 just prior to each ad slot being encountered at the client 502, or in advance of initiation of a streaming session. At 510, the client device 502 may play each the streaming video until reaching one or more designated ad slots. In some embodiments the client 502 may request a video ad in response to detecting the beginning of a designated ad slot, such as, for example, about five seconds before reaching the ad slot during play of a streaming video. The ad server 504 may serve the video ad in response to the request. In alternative embodiments, the ad server 504 may automatically select and include a streaming video ad in the content streamed to the client device, without responding to a request from the client for a video ad.

In whatever manner the video ad is provided, the client may detect, at 512, the identity of a video ad playing in the ad slot. For example, the ad server 504 may provide a video ad identifier in streaming metadata. At 514, the client device 502 may request an additional ad object. The request 514 may be transmitted in the form of an electronic message of any suitable type. Optionally, the request 514 may include a parameter specific to the client device or user account, for example, a current location of the client device. In the alternative, or in addition, the parameter may be provided at a different time, for example when requesting the customized address at 524 or prior to initiating the streaming session at 508.

At 516, the ad server 504 may retrieve the requested ad object, e.g., an interactive banner ad. The requested object may be the same regardless of the parameter value, for example, not customized for the request. Instead, the ad object may be the same for all requests based on a particular video ad. This may enable the ad server to more easily prepare the ad object without having to customize the ad object for each different locale or other parameter. At the same time, the ad object is a distinct object separate from the related video ad, for example a banner ad for a product or brand advertised in the video ad. At 518, the ad server may serve the ad object to the client device as an object separate from the streaming video.

At 520, the client device 502 may display or otherwise output the ad object for a period of time determined at least in part by the video ad. For example, the client device may display an interactive banner ad object while the video ad is playing, optionally plus an additional time after the video ad is finished, for example until the next video ad. The ad object may be displayed in an area of the screen away from the window in which video ad and video content appear, so as to not interfere with the user's view of the video ad or content. The ad object may be configured to be interactive, such that a user selection action (e.g., click on or voice command) causes a corresponding reaction at the client device. Accordingly, at 522, the client device may detect a selection action directed to the interactive ad object. If no selection is detected at 522, the client device may continue to play the streaming video without performing the additional downstream actions diagrammed in FIG. 5.

In response to detecting the selection of the ad object, at 524 the client device 502 may request a customized address (e.g., URL) for additional advertising content from the ad server 504 or other resource. In response to receiving a request for a customized address, the ad server 504 may look up an address at 526, for example by querying an address database using an identifier for the video ad or ad object, plus one additional parameter such a location of the client device or demographic characteristic of an identified user of the client device. At 528, the ad server may provide the address to the client device. Upon receiving the additional content address, the client device 502 may, at 530, request the additional content from the additional content server 501. At 532, the additional content server 501 may serve the requested content in response to receiving the request 530, which the client device may display at 534, for example in an additional window or the like. Thus, the client device 504 may display the additional content customized for its location or other parameter, based on the identity of the video ad. Other client devices playing the same video ad in different locations may likewise display different additional content for the same video ad.

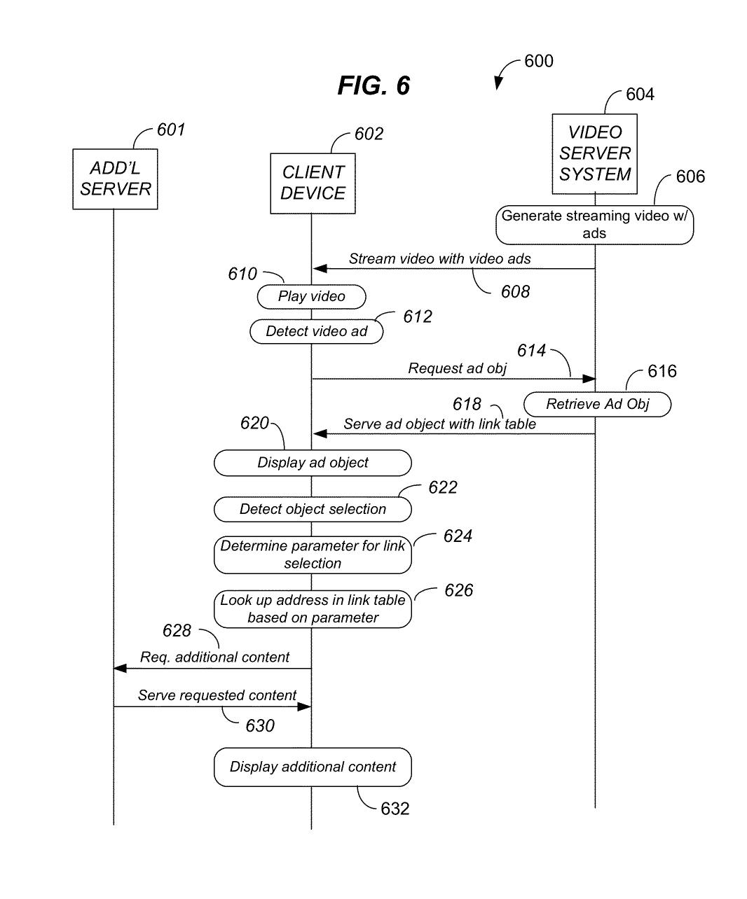

In the foregoing example, the ad server 504 (or other designated external resource) maintains and provides a customized address for the additional content. In an alternative embodiment, a link table of different addresses may instead be provided to the client device. FIG. 6 shows a call flow 600 between a server system 604 and a client device 602 for customizing additional content provided with advertisements in a video segment using a downloaded link table. The call flow 600 likewise may include interactions with an additional content server 601 that prepares and distributes localized or demographically targeted content related to video advertising.

At 606, the server system 604 may determine a selection of advertising videos and ad slots for a video segment requested by client device 602, using any suitable process such as, for example, described herein. At 608, the server system 604 may stream the video segment configured with video advertising. At 610, the client device may play the streaming video segment configured with video advertising at designated ad slots using a media player component. Video advertisements may be selected by the server system 604 just prior to each ad slot being encountered at the client 602, or in advance of initiation of a streaming session. At 610, the client device 602 may play the streaming video until reaching one or more designated ad slots. At 612, the client may detect the identity of a video ad playing in the ad slot. At 614, the client device 602 may request an additional ad object. The request 614 may be transmitted in the form of an electronic message of any suitable type.

At 616, the ad server 604 may retrieve the requested ad object, e.g., an interactive banner ad. The requested object may be the same regardless of the parameter value, for example, not customized for the request. Instead, the ad object may be the same for all requests based on a particular video ad. The ad object may be a distinct object separate from the related video ad, for example an interactive banner ad for a product or brand advertised in the video ad. In addition, the ad server 604 may retrieve a link table relating different addresses to one or more different parameter values, based on the identity of the video ad. For example, the link table may include two or more different network addresses each associated via the table structure with a respective different location and/or demographic parameter. At 618, the ad server may serve the ad object to the client device as an object separate from the streaming video with the link table.

At 620, the client device 602 may display or otherwise output the ad object for a period of time determined at least in part by the video ad. For example, the client device may display an interactive banner ad object while the video ad is playing, optionally plus an additional time after the video ad is finished. The ad object may be configured to be interactive, such that a user selection action (e.g., click on or voice command) causes a corresponding reaction at the client device. Accordingly, at 622, the client device may detect a selection action directed to the interactive ad object. If no selection is detected at 622, the client device may continue to play the streaming video without performing the additional downstream actions diagrammed in FIG. 6.

In response to detecting the selection of the ad object, at 624 the client device may determine a current parameter value for link selection. For example, the client device may determine its own location using a GPS locating device, by user account information, or based on its network connection. Subsequently at 626 the client device 602 may determine a customized address (e.g., URL) for additional advertising content from the ad server 604 or other resource, based on looking up a location or demographic parameter in the link table to discover the address. Upon determining the additional content address, the client device 602 may, at 628, request the additional content from the additional content server 601. At 630, the additional content server 601 may serve the requested content in response to receiving the request 628, which the client device may display at 632, for example in an additional window or the like. Thus, the client device 604 may display the additional content customized for its location or other parameter, based on the identity of the video ad. Other client devices playing the same video ad in different locations may likewise display different additional content for the same video ad.

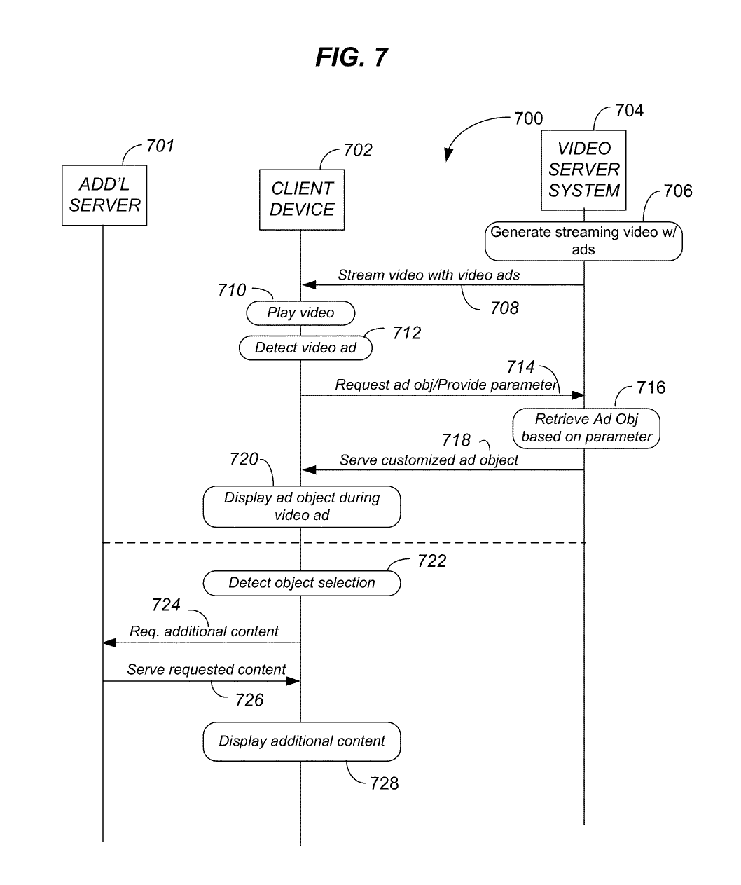

In embodiments using the call flows 500, 600 or similar flow, an interactive ad object that is not customized (and is therefore the same for all client devices receiving the streaming video ad) is provided to the clients and used to trigger additional customized content in response to user selection input. An advantage of such embodiments may include flexibility and greater efficiency in defining and changing (e.g., adding or deleting) customizable content for a particular area or demographic. In alternative embodiments, the interactive ad object may be customized to request particular content for a user's location or demographic. FIG. 7 shows a call flow 700 between a server system 704 and a client device 702 for customizing additional content provided with advertisements in a video segment using a downloaded link table, according to such alternative embodiments. The call flow 700 likewise may include interactions with one or more additional content servers, e.g., server 701, used for distributing localized or demographically targeted content related to video advertising.

At 706, the server system 704 may determine a selection of advertising videos and ad slots for a video segment requested by client device 702, using any suitable process. At 708, the server system 704 may stream the video segment configured with video advertising slots and/or with video advertising. At 710, the client device may play the streaming video segment configured with video advertising at designated ad slots using a media player component. Video advertisements may be selected by the server system 704 just prior to each ad slot being encountered at the client 702, or in advance of initiation of a streaming session. At 710, the client device 702 may play each the streaming video until reaching one or more designated ad slots. At 712, the client may detect the identity of a video ad playing in the ad slot. At 714, the client device 702 may request an additional ad object. The request 714 may be transmitted in the form of an electronic message of any suitable type. The request 714 may include an additional parameter, e.g. location information pertaining to a present or past location of the client device, or demographic information for a user of the client device. In an alternative, the additional location or demographic parameter may be provided from the client 702 to the server 704 at a different time, or obtained by the server 704 by another method.

At 716, the ad server 704 may retrieve the requested ad object, e.g., an interactive banner ad, based on the parameter value. The interactive ad object may be customized based on the parameter value to include specific content, including but not limited to a link to particular additional content. The ad object may be a distinct object separate from the related video ad, for example an interactive banner ad for a product or brand advertised in the video ad. The interactive ad object may be selected by the ad server 704 based on (for example, by querying) a database of other data structure relating different addresses to one or more different parameter values and to the identity of the video ad. For example, a database may include two or more different network addresses each associated via the database with a respective different location and/or demographic parameter. At 718, the ad server may serve the ad object to the client device as an object separate from the streaming video with the link table.

At 720, the client device 702 may display or otherwise output the ad object for a period of time determined at least in part by the video ad. For example, the client device may display a customized interactive banner ad object while the video ad is playing, optionally plus an additional time after the video ad is finished.

In some embodiments, the ad object may be configured to be interactive, such that a user selection action (e.g., click on or voice command) causes a corresponding reaction at the client device. Accordingly, at 722, the client device may detect a selection action directed to the interactive ad object. If no selection is detected at 722, the client device may continue to play the streaming video without performing the additional downstream actions diagrammed in FIG. 7.

In response to detecting the selection of the ad object, at 724 the client device 702 may request the additional content from the additional content server 701. The client 702 may obtain a link or address for the additional content from the interactive ad object, in which the link or address may be included as an attribute or metadata. At 726, the additional content server 701 may serve the requested content in response to receiving the request 724, which the client device may display at 728, for example in an additional window or the like. Thus, the client device 704 may display the additional content customized for its location or other parameter, based on the identity of the video ad. Other client devices playing the same video ad in different locations may likewise display different additional content for the same video ad.

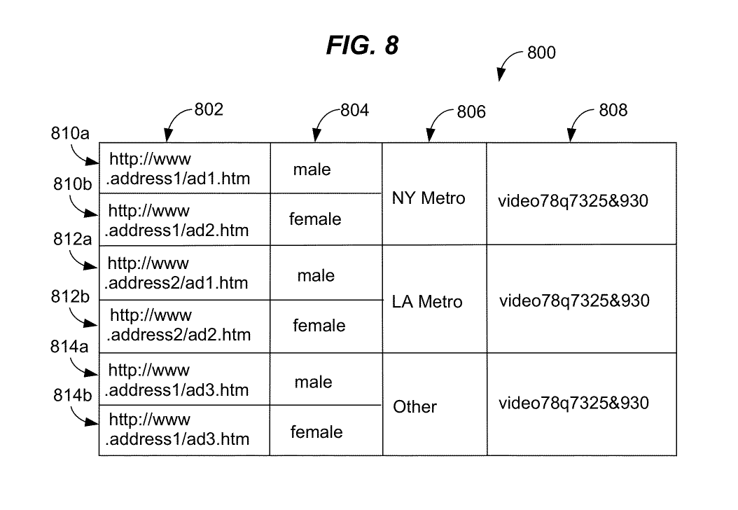

FIG. 8 shows a simplified data structure 800 (e.g., data table) recording relationships or associations between video ad identifiers in column 808, location or demographic parameters in columns 806 or 804, respectively, and addresses for additional content in column 802. It should be appreciated that the data table 800 is simplified for illustrative purposes, including simplified labels, identifiers and data structure, to better illustrate fundamental concepts of a data structure for use with the technology described herein. For example, a similar data structure may be queried by an ad server or client device to locate an address for customized additional content in response to user selection of a companion ad.

Row 810a relates or associates the network address “http://www.address1/ad1.htm” to the demographic parameter “male” and the geographic location parameter “NY Metro,” for the video ad identified as “video78q7325&930.” Row 810b relates or associates the different network address “http://www.address1/ad2.htm” to the demographic parameter “female” and the same location parameter and video ad identifier as row 810a. Row 812a relates or associates the different network address “http://www.address1/ad1.htm” to the demographic parameter “male,” the location parameter “LA Metro” and the same video ad identifier as row 810a. Row 812b relates or associates the different network address “http://www.address2/ad2.htm” to the demographic parameter “female” and the same location parameter and video ad identifier as row 812a. Row 814a relates or associates the different network address “http://www.address1/ad3.htm” to the demographic parameter “male,” the location parameter “Other” and the same video ad identifier as row 810a. Row 814b relates or associates the network address “http://www.address1/ad3.htm” to the demographic parameter “female” and the same location parameter and video ad identifier as row 814a. Based on rows 814a and 814b, by way of illustration only, the same addresses are specified for the different demographic parameters “male” and “female,” for the “Other” (e.g., default) location parameter and video ad identifier common to rows 814a-b.

By way of example only, FIG. 9 illustrates a simplified screenshot 900 of a user interface 901 and additional area 914 for customizing additional content provided with advertisements in a video segment. The user interface 901 may be output by a media player component as described herein to a display device connected to, or incorporated in a client device. The interface 901 may include a video window or screen area 902 in which frames of the streaming video segment are successively displayed, including advertising during defined ad slots. The interface 901 may further include a current time indicator 904 and a total length indicator 906. The interface 901 may include progress bar or timeline 906 for the video segment, which may include graphical indications 907, 910 of ad slots defined in the timeline, and an indication of current progress 908 relative to the timeline 906. At the depicted instant, the progress indicator 908 shows that play has progressed to the first ad slot 907. Accordingly, the content appearing in the video area 902 may comprise a frame of a video advertisement. The interface 901 may include other features that are not the subject of the present application.

An interactive ad object, for example, a banner “companion” ad 916 may be displayed in an a display area 914 apart from the video window 902. The ad 916 may accompany a corresponding video ad appearing in the video window 902, and be caused to appear at the same times, or at overlapping times. Some period of time after the video ad is completed, for example between zero and sixty seconds later, the companion ad 916 may be removed from the display area 914. The companion ad 916 may include hypertext or other objects for initiating actions as described in connection with the call flows 500, 600, 700 for interactive ad objects.

In the alternative to the companion ad 916, or in addition, the user interface 901 may be used to display an overlay ad 918 in the video area 902, placed over a portion of the video ad itself or over video content played between video ads. In an implementation using Adobe Flash™, the overlay ad 918 may comprise a “swf” format file, and may include one or more “hotspots” responsive to user selection actions (e.g., clicks). When the client detects a user selection of a hotspot in the overlay ad 918, the client may request additional advertising materials based on the hotspot and/or any combination of parameters, for example viewing preferences, location, or demographic parameters. The additional advertising materials may be presented in a window separate from the user interface 901.

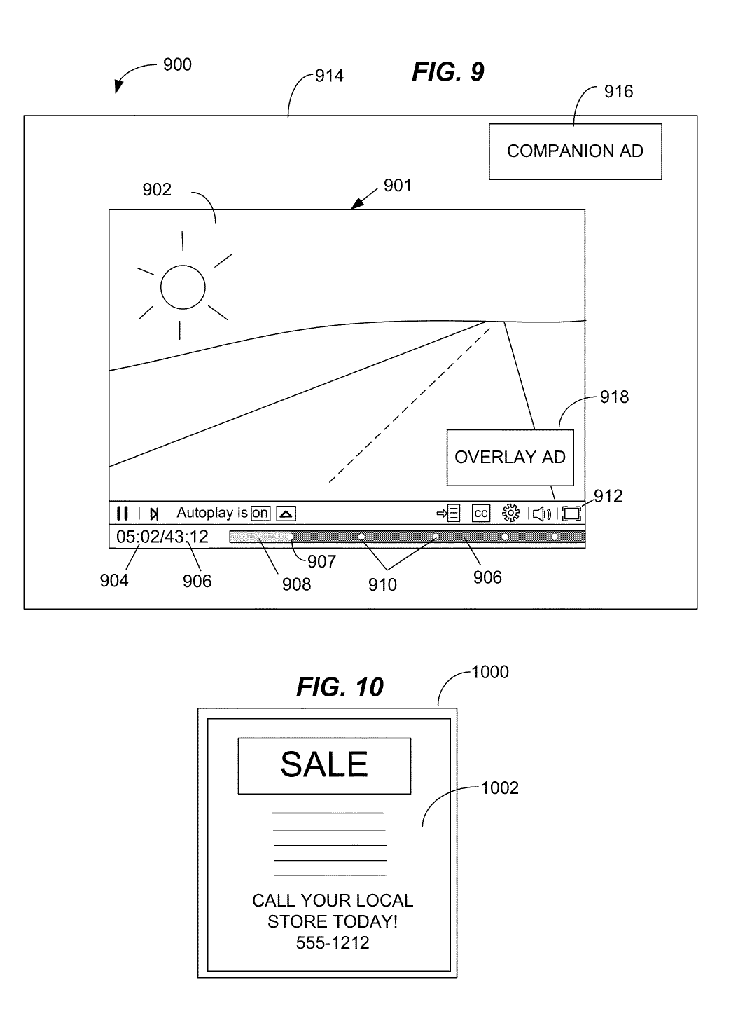

FIG. 10 is a diagram illustrating an example of customized additional content as may be presented on a client device in a window 1000 of a graphical user interface (GUI), in response to user selection of a companion ad 916 or overlay ad 918. The window 1000 may include a display of any content 1002 that is can be output from a window supported by the GUI, for example, text, graphic images, video, and audio. The window 100 may include one or more interactive links to further content pages or the like. The content 1002 may be hosted at any desired location that is addressable within a network to which the client device is connected.

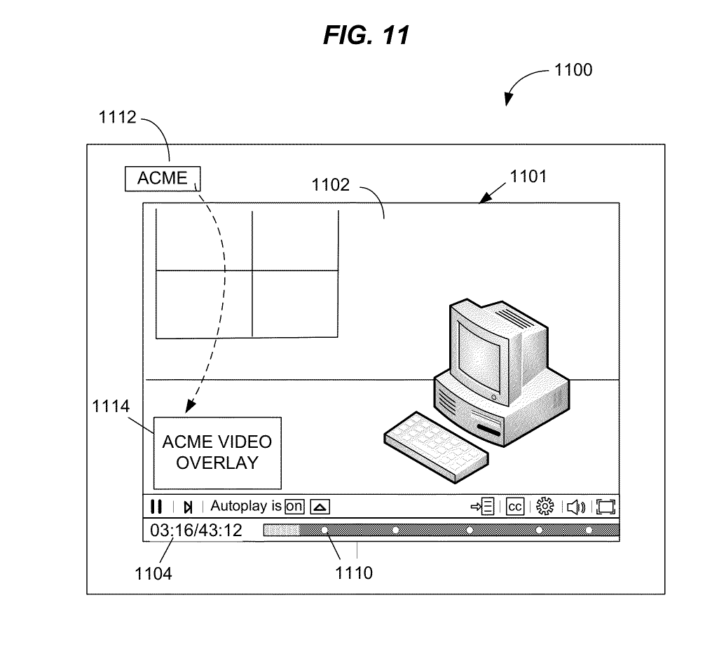

In alternative embodiments, a user may select an overlay video ad to be played at any selected time in a video window. FIG. 11 shows a simplified screenshot 1100 of a user interface 1101 and related features for such embodiments. The user interface 1101 may be similar to the user interface 901, with corresponding features. A logo ad 1112 or button may be displayed near the user interface 1101 during a video streaming session presented in the video window 1102. The logo ad 1112 may be presented for the entirety of the video session. In some embodiments, the logo ad 1112 may be accompanied by a message such as, for example, “brought to you by . . . ” and referring to a sponsor of the video session. The logo ad 1112 and sponsor may be selected in any desired manner for the video streaming session.

At any time during the video session, for example at time 1104, a user may select the logo ad 1112, for example by clicking on the ad 1112, moving a cursor over the ad 1112 by moving a pointing device, or touching the screen area over the ad 1112 if displayed on a touchscreen device. In response to detecting user selection of the ad, the client device may transmit a signal to a video content server. The video content server, in response to receiving the signal, may insert a static or video ad 1114 as an overlay in a small area of the video window. The overlay ad 1114 may be inserted for a limited period of time, for example, as a 15 second, 30 second, or 60 second video or static ad. In an embodiment, the overlay ad 1114 may be only visible between ad slots when no video ad is appearing in the main video window 1102. The video server may limit the number of times the overlay ad will appear during the video streaming session, regardless of how many times a user selects the logo ad 1112. For example, if the overlay ad 1114 is limited to a single appearance, if the user selects the logo ad a second time after the overlay ad 1114 has already appeared, the client may take no action overlay ad will not be shown a second time during the video streaming session.

The foregoing examples may be embodied in one or more methodologies performed by a computer, for example a client device, server, or some combination of a client device and server. Methodologies that may be implemented in accordance with the disclosed subject matter will be better appreciated with reference to various flow charts. Although methodologies are shown and described as a series of acts/blocks for simplicity of illustration, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored as encoded instructions and/or data on an article of manufacture, for example, a non-transitory computer-readable medium, to facilitate storing, transporting and transferring such methodologies to various devices. Those skilled in the art will understand and appreciate that a method could alternatively be represented as a series of interrelated states or events, such as in a state diagram.

### EXAMPLE METHODOLOGIES AND APPARATUS

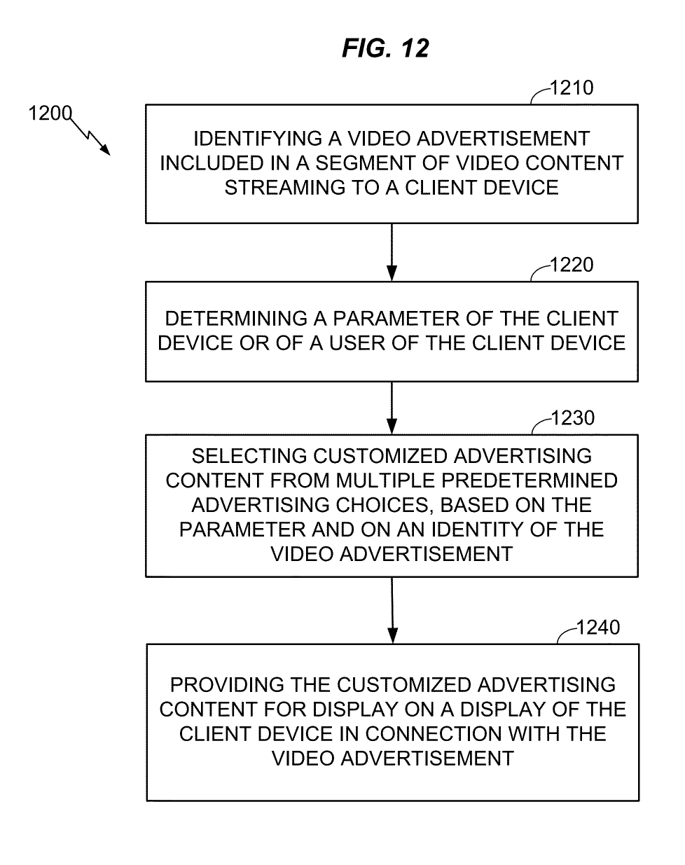

As shown in FIG. 12, a network node or client device, or both, of a computer server system may perform a method 1200 for customizing additional content provided with advertisements in a video segment. The method 1200 may include, at 1210, identifying a video advertisement included in a segment of video content streaming to a client device. Any suitable method may be used for identifying the video ad, and identification may be performed by the client device, server of the video ad, or both. An identification process 1210 may return an identifier, which may be used later in the method 1200. The video ad may be played by a media player module on client device receiving the streaming video in a streaming video session. The identification 1210 may be performed before or during the video session.

The method 1200 may further include, at 1220, determining a parameter of the client device or of a user of the client device, optionally more than one parameter. The parameter may be, or may include, an identifier for a geographical area selected based on location information for the client device. The parameter may be, or may include, demographic information pertaining to a user of the client device, for example, user profile information from a user account for a registered user of the client device. The parameter may be, or may include, user preference or interest information derived from user feedback, past browsing history, or other information.

The method 1200 may further include, at 1230, selecting customized advertising content from multiple predetermined advertising choices, based on the parameter and on an identity of the video advertisement. For example, the client device or server may query a relational data structure using the identifier and the parameter to obtain an address or identifier for customized advertising content.

The method 1200 may further include, at 1240, providing the customized advertising content for display on a display component of the client device in connection with the video advertisement. For example, a client device may use a network address or identifier returned from the selection process 1230 to request the customized content, and then receive the content in response to the request and display the content on the client device using a browser application, media player, or combination thereof

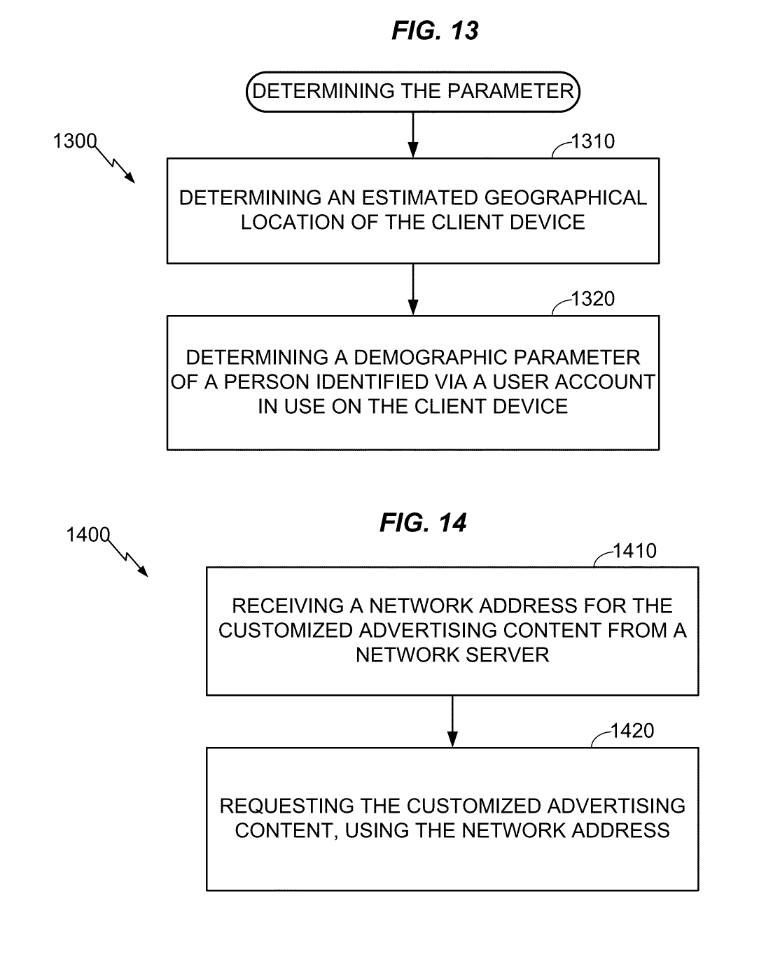

With reference to FIGS. 13-17, several additional operations 1300, 1400, 1500, 1600 and 1700 are depicted for customizing additional content provided with advertisements in a video segment, which may be performed by a computer server, alone or in combination with a client device and/or another server. One or more of operations 1300, 1400, 1500, 1600 and 1700 may optionally be performed as part of method 1200. The elements 1300, 1400, 1500, 1600 and 1700 may be performed in any operative order, or may be encompassed by a development algorithm without requiring a particular chronological order of performance. Operations can be independently performed and are not mutually exclusive. Therefore any one of such operations may be performed regardless of whether another downstream or upstream operation is performed. For example, if the method 1200 includes at least one of the operations 1300, 1400, 1500, 1600 and 1700, then the method 1200 may terminate after the at least one operation, without necessarily having to include any subsequent downstream operation(s) that may be illustrated.

In an aspect, with reference to FIG. 13, the method 1200 may further include additional operations 1300 for determining the parameter 1220. The additional operations may include, at 1310, determining an estimated geographical location of the client device. For example, the client device may receive a triangulating signal, such as a Global Positioning System (GPS) signal, and determine its current position from the GPS signal. The client device may provide GPS coordinate to a server, which may identify a geographic area, for example a marketing area, in which the GPS coordinates are located. For further example, a server may determine an Internet Protocol (IP) address, or other network address assigned to the client device, and estimate a location from the network address. In addition, or in the alternative, the client device may receive user input selecting or specifying a particular geographic area.

The method 1200 may further include, at 1320, determining a demographic parameter of a person identified via a user account in use on the client device. For example, the video stream session may be preceded by an authentication session in which a user of the client device authenticates her identity using a login procedure. The system may develop and store user profile information in connection with the user account, based on user feedback or observations of user behavior while using the system. The demographic parameter may be obtained from the user account by reading a data record in the user profile.

In other aspects, with reference to FIG. 14, the method 1200 may further include, at 1410, receiving a network address for the customized advertising content from a network server. For example, the network server may determine the network address using the selection process 1230, and provide the address to the client device. The address may be, or may include, a Uniform Resource Locator (URL). The method 1200 may further include, at 1420, requesting the customized advertising content, using the network address. For example, the client device may include a URL in a Hypertext Transport Protocol (HTTP) request.

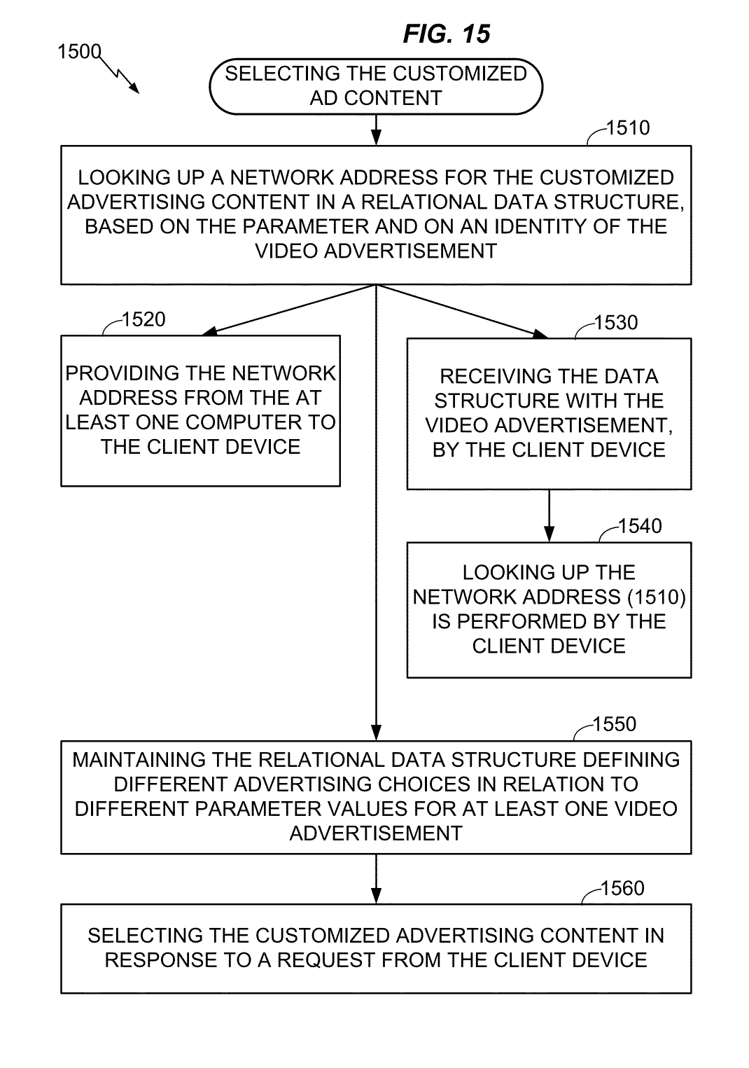

In other aspects, with reference to FIG. 15, the method 1200 may further include for selecting the customized ad content 1230. The additional operations may include, at 1510, looking up a network address for the customized advertising content in a relational data structure, based on the parameter and on an identity of the video advertisement. More than one parameter may be used for looking up the network address in a query or the like.

In an aspect, the method 1200 may further include, at 1520, providing the network address from the at least one computer to the client device. In an alternative or complementary aspect, the method 1200 may further include, at 1530, receiving the data structure with the video advertisement, by the client device. In such case, as indicated at 1540 the operation 1510 of looking up the network address may be performed by the client device, for example using a local link table or by accessing a remote database. In another aspect, the method 1200 may further include, at 1550, maintaining the relational data structure defining different advertising choices in relation to different parameter values for at least one video advertisement. A simple example of such a data structure is described above in connection with FIG. 8. The method 1200 may further include, at 1560, selecting the customized advertising content in response to a request from the client device.

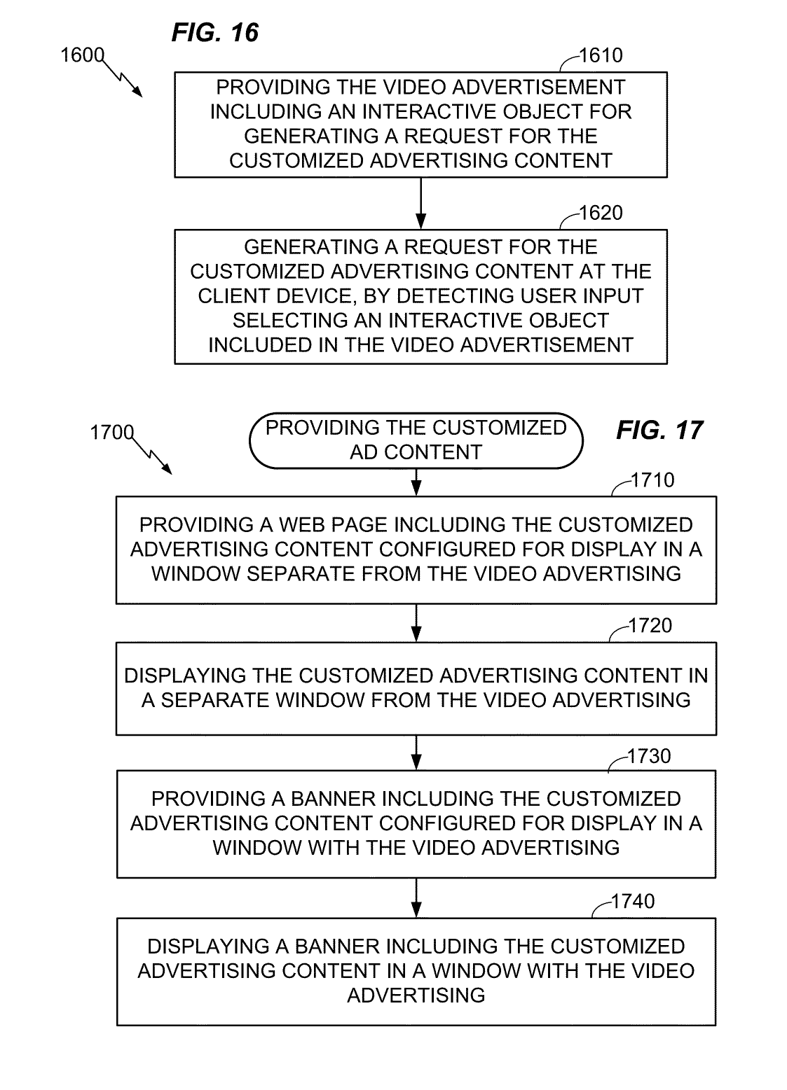

With reference to FIG. 16, the method 1200 may further include, at 1610, providing the video advertisement including an interactive object for generating a request for the customized advertising content. The interactive object may include, for example, a user-selectable banner ad, such as a companion ad, or a video overly object, or some other selectable object for display on the client device. The method 1200 may further include, at 1620, generating a request for the customized advertising content at the client device, by detecting user input selecting an interactive object included in the video advertisement.

In aspects, with reference to FIG. 17, the method 1200 may further include additional operations 1700 for providing the customized ad content 1240. The additional operations may include, at 1710, providing a web page including the customized advertising content configured for display in a window separate from the video advertising. In such case, the method 1200 may further include, at 1720, displaying the customized advertising content in a separate window from the video advertising. In another aspect, the method 1200 may further include, at 1730, providing a banner including the customized advertising content configured for display in a window with the video advertising. In such case, the method 1200 may further include, at 1740, displaying a banner including the customized advertising content in a window with the video advertising.

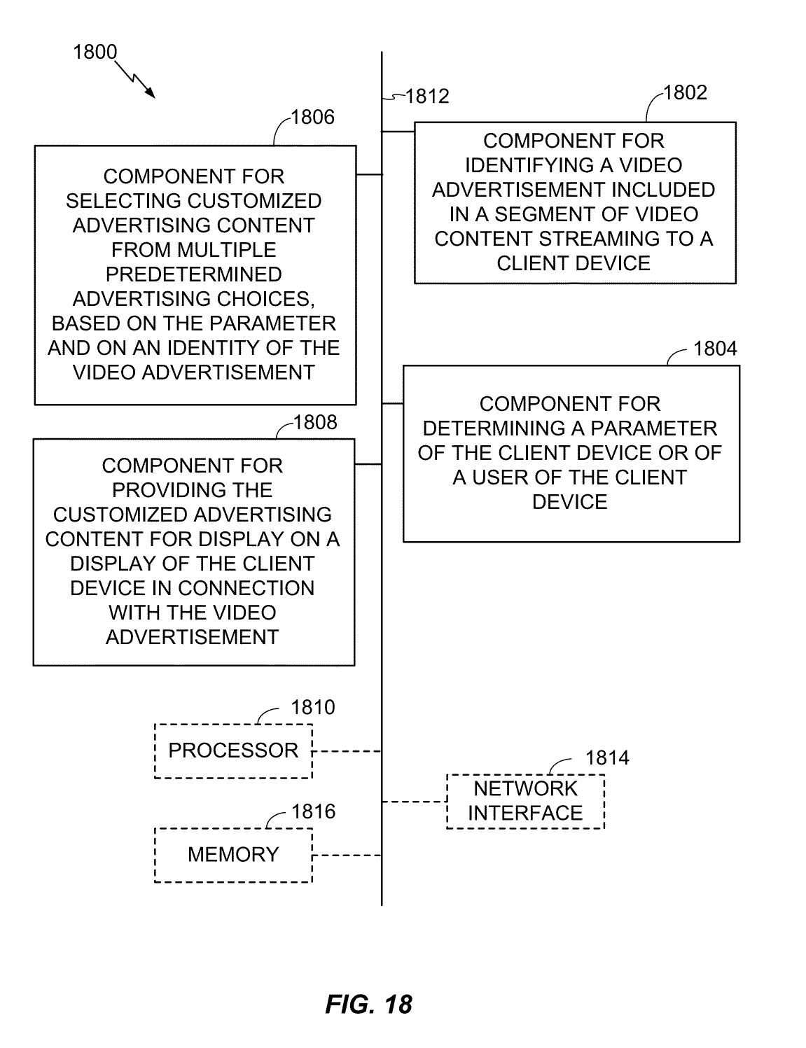

With reference to FIG. 18, there is provided an exemplary apparatus 1800 that may be configured as computer server, client device, or combination of client and server, for customizing additional content provided with advertisements in a video segment. The apparatus 1800 may include functional blocks that can represent functions implemented by a processor, software, or combination thereof (e.g., firmware).

As illustrated, in one embodiment, the apparatus 1800 may include an electrical component or means 1802 for identifying a video advertisement included in a segment of video content streaming to a client device. For example, the electrical component or means 1802 may include at least one control processor 1810 coupled to a memory component 1816. The control processor may operate an algorithm, which may be held as program instructions in the memory component. The algorithm may include, for example, extracting an identifier for the video ad from a header or other associated metadata for a video ad.

The apparatus 1800 may further include an electrical component or module 1804 for determining a parameter of the client device or of a user of the client device. For example, the electrical component or means 1804 may include at least one control processor 1810 coupled to a memory component 1816. The control processor may operate an algorithm, which may be held as program instructions in the memory component. The algorithm may include, for example, one or more of the additional operations 1300 described above in connection with FIG. 13.

The apparatus 1800 may further include an electrical component or module 1806 for selecting customized advertising content from multiple predetermined advertising choices, based on the parameter and on an identity of the video advertisement. For example, the electrical component or means 1806 may include at least one control processor 1810 coupled to a memory component 1816. The control processor may operate an algorithm, which may be held as program instructions in the memory component. The algorithm may include, for example, one or more of the additional operations 1500 described above in connection with FIG. 15.

The apparatus 1800 may further include an electrical component or module 1808 for providing the customized advertising content for display on a display component of the client device in connection with the video advertisement. For example, the electrical component or means 1808 may include at least one control processor 1810 coupled to a memory component 1816. The control processor may operate an algorithm, which may be held as program instructions in the memory component. The algorithm may include, for example, one or more of the additional operations 1700 described above in connection with FIG. 17.

The apparatus 1800 may include similar electrical components for performing any or all of the additional operations 1300, 1400, 1500, 1600 and 1700 described in connection with FIGS. 13-17, which for illustrative simplicity are not shown in FIG. 18.

In related aspects, the apparatus 1800 may optionally include a processor component 1810 having at least one processor, in the case of the apparatus 1800 configured as a network entity or a client device. The processor 1810, in such case may be in operative communication with the components 1802-1808 or similar components via a bus 1812 or similar communication coupling. The processor 1810 may effect initiation and scheduling of the processes or functions performed by electrical components 1802-1808.

In further related aspects, the apparatus 1800 may include a network interface component 1814 enabling communication between a client and a server. The apparatus 1800 may optionally include a component for storing information, such as, for example, a memory device/component 1816. The computer readable medium or the memory component 1816 may be operatively coupled to the other components of the apparatus 1800 via the bus 1812 or the like. The memory component 1816 may be adapted to store computer readable instructions and data for implementing the processes and behavior of the components 1802-1808, and subcomponents thereof, or the processor 1810, or the methods disclosed herein. The memory component 1816 may retain instructions for executing functions associated with the components 1802-1808. While shown as being external to the memory 1816, it is to be understood that the components 1802-1808 can exist within the memory 1816.

It should be understood that the specific order or hierarchy of steps in the processes disclosed are merely examples. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for customizing additional content provided with advertisements, by at least one computer, the method comprising:
receiving a request for customized advertising content based on an interaction with an interactive advertisement being output at a client device while a video advertisement is streamed during an ad break in video content being streamed to the client device, wherein the interactive advertisement is not customized for the client device;
in response to receiving the request based on the interaction with the interactive advertisement, performing:
identifying the video advertisement being streamed during the ad break while the interactive advertisement is output at the client device;
determining a parameter of the client device or of a user of the client device;
selecting customized advertising content from multiple predetermined advertising choices based on the parameter and on an identity of the video advertisement determined based on the identifying; and
providing the customized advertising content for display on a display of the client device in connection with the video advertisement.

2. The method of claim 1, further comprising determining the parameter based on information received from the client device in connection with a request for the video content.

3. The method of claim 1, wherein determining the parameter comprises determining an estimated geographical location of the client device.

4. The method of claim 1, wherein determining the parameter comprises determining a demographic parameter of a person identified via a user account in use on the client device.

5. The method of claim 1, wherein selecting the customized advertising content further comprises looking up a network address for the customized advertising content in a relational data structure based on the parameter and on the identity of the video advertisement.

6. The method of claim 5, further comprising providing the network address from the at least one computer to the client device.

7. The method of claim 5, further comprising receiving the data structure with the video advertisement, by the client device.

8. The method of claim 7, wherein looking up the network address is performed by the client device.

9. The method of claim 5, further comprising maintaining the relational data structure defining different advertising choices in relation to different parameter values for at least one video advertisement.

10. The method of claim 1, further comprising receiving a network address for the customized advertising content from a network server.

11. The method of claim 10, further comprising requesting the customized advertising content using the network address.

12. The method of claim 1, further comprising providing the video advertisement including an interactive object for generating a request for the customized advertising content.

13. The method of claim 1, further comprising performing selecting the customized advertising content in response to a request from the client device.

14. The method of claim 1, further comprising receiving the request for the customized advertising content at the client device based on a user input selecting the interactive object associated with the video advertisement.

15. The method of claim 1, wherein providing the customized advertising content further comprises providing a Web page including the customized advertising content configured for display in a window separate from the video advertising.

16. The method of claim 1, wherein providing the customized advertising content further comprises displaying the customized advertising content in a separate window from the video advertisement.

17. The method of claim 1, wherein providing the customized advertising content further comprises providing a banner including the customized advertising content configured for display in a window with the video advertisement.

18. The method of claim 1, wherein providing the customized advertising content further comprises displaying a banner including the customized advertising content in a window with the video advertisement.

19. The method of claim 1, wherein the at least one computer comprises the client device.

20. The method of claim 1, wherein the at least one computer comprises a network server in communication with the client device.

21. An apparatus, comprising:
at least one processor configured for:
receiving a request for customized advertising content based on an interaction with an interactive advertisement being output at a client device while a video advertisement is streamed during an ad break in video content being streamed to the client device, wherein the interactive advertisement is not customized for the client device;
in response to receiving the request based on the interaction with the interactive advertisement, performing:
identifying the video advertisement being streamed during the ad break while the interactive advertisement is output at the client device;
determining a parameter of the client device or of a user of the client device;
selecting customized advertising content from multiple predetermined advertising choices based on the parameter and on an identity of the video advertisement determined based on the identifying; and
providing the customized advertising content for display on a display of the client device in connection with the video advertisement; and
a memory coupled to the at least one processor for storing data.

22. The apparatus of claim 21, wherein the processor is further configured for determining the parameter based on information received from the client device in connection with a request for the video content.

23. The apparatus of claim 21, wherein the processor is further configured for determining the parameter including determining an estimated geographical location of the client device.

24. The apparatus of claim 21, wherein the processor is further configured for determining the parameter including determining a demographic parameter of a person identified via a user account in use on the client device.

25. The apparatus of claim 21, wherein the processor is further configured for selecting the customized advertising content by looking up a network address for the customized advertising content in a relational data structure based on the parameter and on the identity of the video advertisement.

26. The apparatus of claim 25, wherein the processor is further configured for providing the network address to the client device.

27. The apparatus of claim 25, wherein the processor is further configured for providing the data structure with the video advertisement to the client device.

28. The apparatus of claim 25, wherein the processor is further configured for maintaining the relational data structure defining different advertising choices in relation to different parameter values for at least one video advertisement.

29. The apparatus of claim 21, wherein the processor is further configured for receiving a network address for the customized advertising content from a network server.

30. The apparatus of claim 29, wherein the processor is further configured for requesting the customized advertising content, using the network address.

31. The apparatus of claim 21, wherein the processor is further configured for providing the video advertisement including the interactive object for generating the request for the customized advertising content.

32. The apparatus of claim 21, wherein the processor is further configured for selecting the customized advertising content in response to a request from the client device.

33. The apparatus of claim 21, wherein the processor is further configured for generating a request for the customized advertising content at the client device by detecting user input selecting an interactive object included in the video advertisement.

34. The apparatus of claim 21, wherein the processor is further configured for providing the customized advertising content including providing a Web page including the customized advertising content configured for display in a window separate from the video advertisement.

35. The apparatus of claim 21, wherein the processor is further configured for providing the customized advertising content including displaying the customized advertising content in a separate window from the video advertisement.

36. The apparatus of claim 21, wherein the processor is further configured for providing the customized advertising content including providing a banner including the customized advertising content configured for display in a window with the video advertisement.

37. The apparatus of claim 21, wherein the processor is further configured for providing the customized advertising content including displaying a banner including the customized advertising content in a window with the video advertisement.

38. A computer program product, comprising:
a non-transitory computer-readable medium holding coded instructions, that when executed by a processor, causes a computer to:
receive a request for customized advertising content based on an interaction with an interactive advertisement being output at a client device while a video advertisement is streamed during an ad break in video content being streamed to the client device, wherein the interactive advertisement is not customized for the client device;
in response to receiving the request based on the interaction with the interactive advertisement, perform:
identify the video advertisement being streamed during the ad break while the interactive advertisement is output on the client device;
determine a parameter of the client device or of a user of the client device in response to the interaction with the interactive advertisement at the client device;
select customized advertising content from multiple predetermined advertising choices based on the parameter and on an identity of the video advertisement determined based on the identifying; and
provide the customized advertising content for display on a display of the client device in connection with the video advertisement.
